(19) United States
(12) Patent Application Publication
(10) Pub. No.: US 2026/0295615 A1
(43) Pub. Date: Oct. 1, 2026

(54) TRIGGER DISPENSING HEAD FOR A LIQUID PRODUCT DISPENSING DEVICE

(71) Applicant: GUALA DISPENSING S.P.A., Alessandria (IT)

(72) Inventor: Mauro MULVONI, Alessandria (IT)

(21) Appl. No.: 19/477,992

(22) PCT Filed: Mar. 6, 2024
(86) PCT No.: PCT/IB2024/052154

§ 371 Date: Oct. 23, 2025

(30) Foreign Application Priority Data
Apr. 28, 2023 (WO) PCT/IB2023/054473
Jun. 8, 2023 (IT) 102023000011736
Jun. 8, 2023 (IT) 202023000002421

(51) Int. Cl. B05B 11/10; B65D 1/02; B65D 47/00

(52) U.S. Cl. CPC B05B 11/1038; B65D 1/0207; B65D 47/00

(57) ABSTRACT

A trigger dispensing head for a liquid product dispensing device has a chassis, a pumping member, an extension, a trigger, a nozzle, a cover, and a ring nut. All components are made of polyethylene but have differing features. A tube of the pumping member and a guide wall of the chassis make a first seal that is both static and slidable between the components made of polyethylene.

### TECHNICAL FIELD

The present invention is in the field of trigger dispensing devices for the delivery of a product, usually a liquid, intended for example for household hygiene, the care of fabrics or garments, personal hygiene, hobby activities, and countless others. In particular, the subject matter of the present invention is a trigger dispensing head that may be applied to a bottle, a dispensing device consisting of the dispensing head applied to the bottle, and the individual components of the dispensing head.

### PRIOR ART

The Applicant is the holder of numerous International Applications in relation to trigger dispensing devices and the parts thereof.

The majority of the components of such devices are made of a plastic material, generally of differing families, chosen in order to satisfy project requirements: component strength and reliability, complex shape moldability, weight reduction and many others. Some components, in some known solutions, are however made from non-plastic materials, such as for example elastic elements from a metallic material.

In recent years the Applicant has made significant research efforts aimed at making devices with a reduced environmental impact, suitable for example for being internally disposed of in plastic collection containers thereby avoiding the use of non-plastic materials. For example, the trigger produced and marketed by the Applicant known on the market by the commercial name “ATOM Z” is entirely made from plastic materials.

However such devices sometimes have inter-component sealing and strength features that do not fully meet some particular market requirements.

### OBJECT OF THE INVENTION

The object of the invention is to satisfy the requirement to provide a trigger dispensing head and a dispensing device composed of the dispensing head applied to a bottle and composed of plastic material components, whilst at the same time overcoming the drawbacks mentioned above.

This object is achieved by a trigger dispensing head according to claim 1. The claims dependent thereon identify additional advantageous embodiments of the invention.

### BRIEF DESCRIPTION OF THE DRAWINGS

The features and advantages of the trigger dispensing head according to the present invention will be apparent from the description mentioned below, given by way of non-limiting example in accordance with the figures in the accompanying drawings, wherein:

FIG. 1 is a longitudinal-sectional view of a trigger dispensing head, according to one embodiment of the present invention;

FIGS. 2 to 4 depict the trigger dispensing head of FIG. 1, in various operational configurations;

FIG. 5 is a longitudinal-sectional view of a trigger dispensing head according to a further embodiment of the present invention;

FIGS. 6 to 8 depict the trigger dispensing head of FIG. 5, in various operational configurations.

### DETAILED DESCRIPTION OF EMBODIMENTS OF THE INVENTION ST EMBODIMENT (NOT PRE-COMPRESSED)

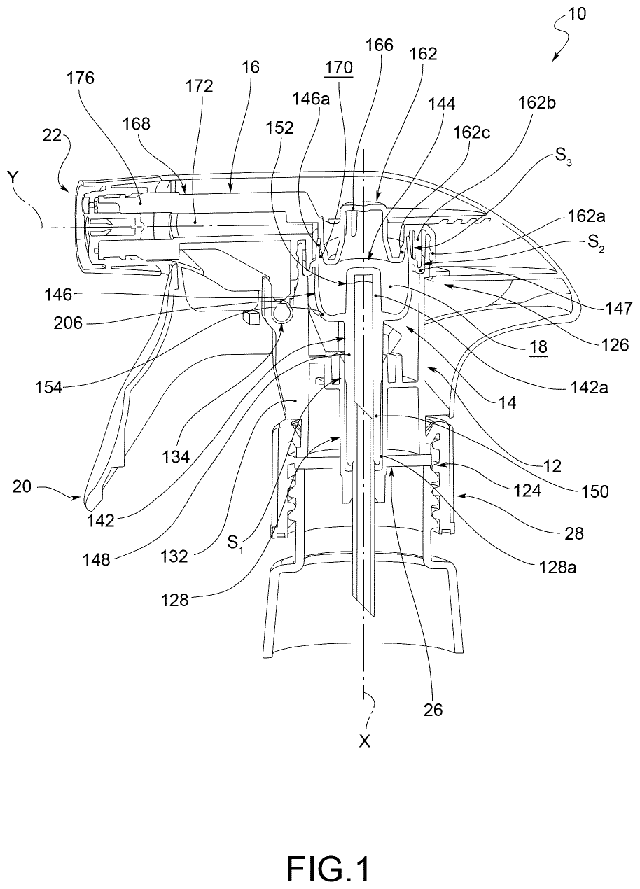

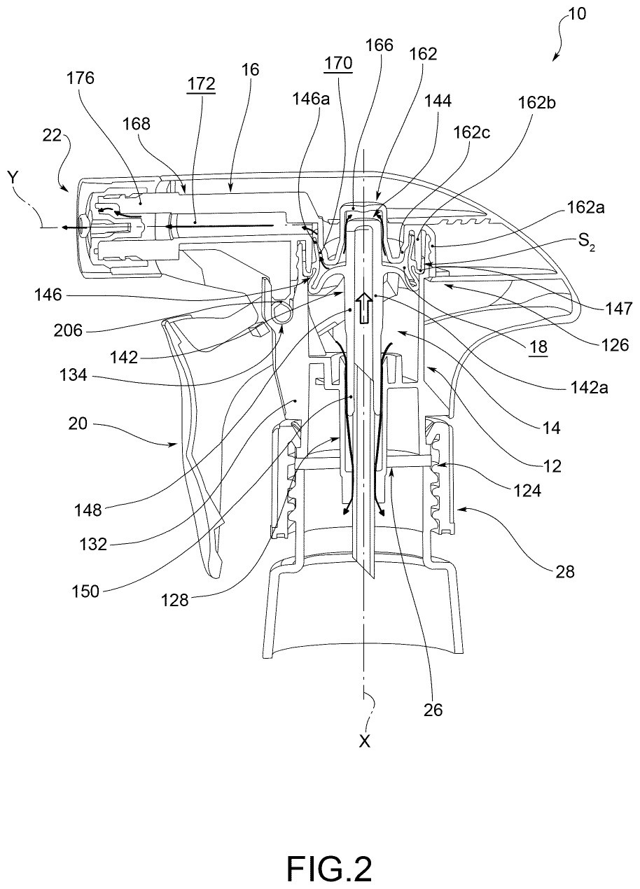

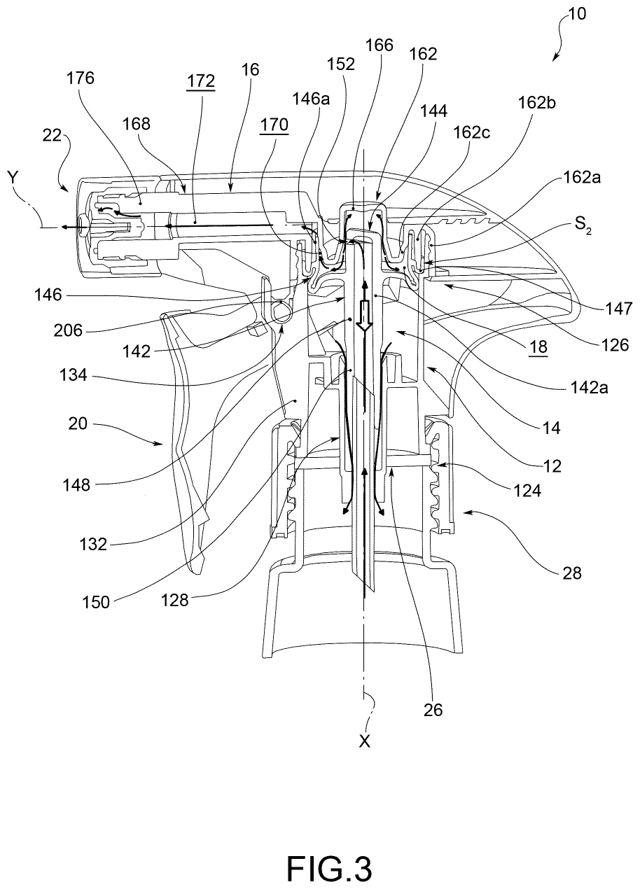

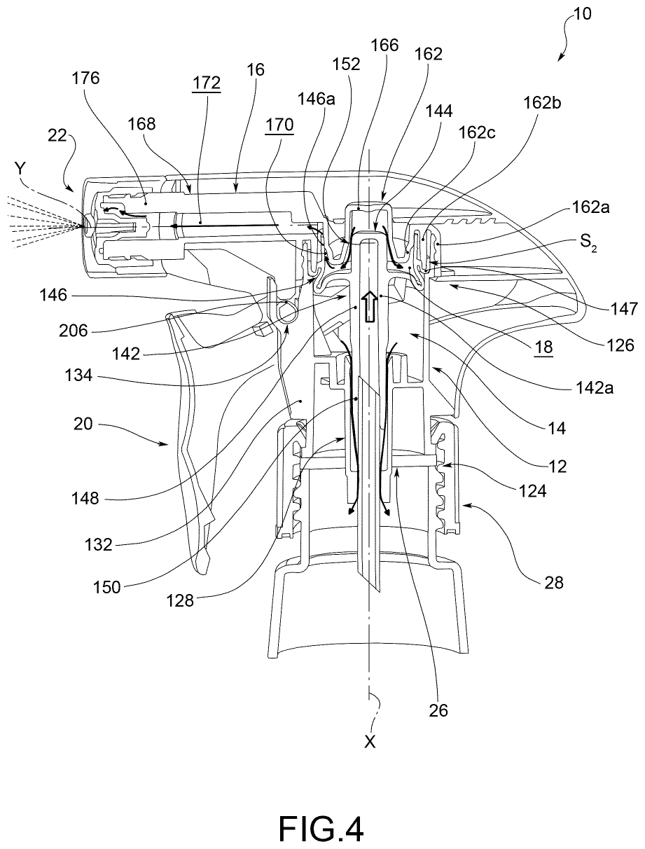

According to a first embodiment (FIGS. 1 to 4), a trigger dispensing device consists of a bottle for containing liquid, provided with a neck terminating with a mouth delimited annularly by a support area in the form of a circular crown, and a trigger dispensing head 10, applied to the bottle in such a way as to sealingly rest upon the support area of the neck.

The dispensing head 10 comprises a chassis 12, a pumping member 14, an extension 16, a trigger 20, a nozzle 22, a cover 24, a washer 26, and a ring nut 28.

### The Chassis 12

The dispensing head 10 comprises a chassis 12 for connecting and supporting the components of the dispensing head; in particular, the chassis 12 is tubular and comprises an annular chassis side wall 122 that extends from a lower end 124 to an upper end 126 along a chassis axis X.

In proximity to the lower end 124 the chassis 12 comprises, substantially internally, a cylindrical annular guide wall 128, coaxial to the chassis axis X and partially protruding below the lower end 124. The guide wall 128 delimits a guide compartment 128a, open at the bottom.

At the upper end 126 the chassis 12, on the other hand, comprises a coupling portion 130 for mechanically connecting to an extension 16 which will be described hereinafter.

Between the lower end 124 and the upper end 126, at the front, the chassis side wall 122 comprises an engagement portion 132 wherein a seat 134 open at the top is obtained for a trigger 20, to be discussed hereinafter.

The chassis 12 is made of polyethylene in a single piece, for example by injection molding.

In particular, the chassis material has an elastic modulus (measured according to ISO 527) >1600 MPa and a yield strength (measured according to ISO 527 or ASTM D638) ≤26 MPa.

Advantageously, the chassis has sufficient rigidity and is dimensionally stable to ensure the connection to the other components.

### The Pumping Member 14

The dispensing head 10 furthermore comprises a pumping member 14 comprising a tube 142, a head 144 and a cup 146.

The tube 142, open below, is coaxial to the chassis axis X and partially inserted and slidable within the guide wall 128 of the chassis 20.

Said tube 142 comprises an upper segment 148 and a lower segment 150, wherein the upper segment 148 has a larger outer diameter than the lower segment 150 and is sealingly slidable in relation to the guide wall 128 of the chassis 12, in order to prevent the accidental spilling of the liquid product from the bottle through the guide compartment 128a. The lower segment 150 and the guide wall 128, on the other hand, form a diametric gap for the entry of air into the bottle through the guide compartment 128a from the external environment during the step of suctioning the liquid product.

In other words, between the upper segment 148 of the tube 146 and the guide wall 128 of the chassis 12 there is a first seal S1 which is suitable for preventing product leakages.

At the lower end of the tube 142 a suction tube is usually inserted, which terminates within the bottle after having passed through the guide compartment 128a, which is open at the bottom.

The head 150 is arranged at the top of the tube 142, partially separated therefrom by an incision 152 for the passage of the liquid product during a suction step.

The cup 146 is arranged in proximity to the upper end of the pumping tube 142, and surrounds a final segment 142a of said tube 142, which is joined to the head 144. The cup 146 terminates above with an annular end segment 146a and furthermore comprises an engagement portion 154 below that is configured to be subjected to the action of a trigger 20 to be discussed hereinafter.

The pumping member 14 furthermore comprises a flange 147 radially extending outward from the cup 146, for example in an “S” shape, compressed between the chassis 12 and the extension 16, creating a second seal S2 against product leakage.

The pumping member 14 is made of polyethylene in a single piece, for example by injection molding. In particular, the material has a melt flow rate >6 g/10 minutes (measured according to ISO 1133, at 190° C./2.16 kg), an ultimate tensile strength ≤20 MPa (measured according to ISO 527) and an ultimate elongation ≥900% (measured according to ISO 527).

Advantageously, this ensures a high component moldability and an adequate elasticity as required by the function of the component itself. Furthermore, the Applicant has observed that an excellent seal against product leakage between the pump and the frame was obtained at the first seal S1, which is primarily a static seal for preventing product loss during transportation, but also a dynamic seal for certain segments of travel of the pumping member, in order to ensure the venting of the device. All of this is fully functional despite the use of polyethylene having differing features between one component and another.

### The Extension 16

The dispensing head 10 furthermore comprises an extension 16.

The extension 16 comprises a connecting portion 162 which is applied by snapping onto the chassis 12.

In particular, the connecting portion 162 comprises an annular outer wall 162a having a predefined axial extension for the connection by snapping onto the coupling portion 130 of the chassis 12.

Furthermore, the connecting portion 162 comprises an annular intermediate wall 162b, having a predefined axial extension, arranged radially inside the outer wall 162a, which engages the flange 147 of the pumping member 14 to compress it against the coupling portion 130 of the chassis 12, thus attaching the pumping member 14.

Additionally, the connecting portion 162 comprises an annular inner wall 162c, having a predefined axial extension, arranged radially inside the intermediate wall 162b, whereupon, during a suction step of the liquid product, it sealingly supports the end segment 146a of the cup 146 thereby implementing a third seal S3.

The connecting portion 162 furthermore comprises a bell 166 which is coaxial to t the chassis 12, radially inside the inner wall 162c, configured in such a way as to surmount and be aligned with the final segment 142a of the tube 142. The bell 166 is suitable for receiving at least in part the final segment 142a of the tube 142 in a limit dispensing configuration of the liquid product.

The extension 16 furthermore comprises a dispensing portion 168, partially separated from the connecting portion 162 by an annular passage 170 wherein the end segment 146a of the cup 146 is housed. The end segment 146a is suitable for sealingly closing the passage 170. The cup 146 and the bell 166 delimit in this way a pressure chamber 18 for containing the liquid product to be dispensed.

The dispensing portion 168 furthermore comprises a dispensing duct 172 that extends from a rear end 174, suitable for being placed in fluidic communication with the pressure chamber 18 via the passage 170, to a front end 176, which is open to the external environment in order to dispense the liquid, along a dispensing axis Y, perpendicular to the chassis axis 12.

The extension 16 furthermore comprises an engagement portion 178, which extends from the dispensing portion 168 towards the seat 134 of the chassis 12 via the trigger 20.

The extension 16 is made of polyethylene in a single piece, for example by injection molding.

In particular, the material of the extension has an elastic modulus or flexural modulus of elasticity (measured according to ASTM D790) of between 1300 and 1500 MPa, a yield strength ≥30 MPa and an ESCR (Environmental Stress Cracking Resistance: evaluation of the resistance of polymeric materials to breakage due to attack by chemical reagents) with the first break detected at ≥168 hours.

Advantageously, the extension has sufficient rigidity and dimensional stability to ensure coupling to other components of the device and excellent resistance to chemical attack. The Applicant has also observed that an excellent seal against product leakage was obtained at the third seal S3, despite the use of polyethylene having differing features amongst the various components.

### The Trigger 20

The dispensing head 10 furthermore comprises a manually actuated trigger 20.

The trigger 20 comprises a lever 202 that is suitable for being squeezed by the fingers of a user, generally by the index finger and by the middle finger, an operating portion 204 extending from the lever 202 towards the cup 146 of the pumping member 12 and that is configured in order to operate upon the engagement portion 154 of the cup 146 to deform it during a step of dispensing the liquid product, and a hinge portion 206 extending from the engagement portion 154 and accommodated in the seat 134 to form a pivot pin. The hinge portion 206 is kept in the seat 134 by the engagement portion 178 of the extension 16.

The trigger is made of polyethylene in a single piece, for example by injection molding.

In particular, the material has an elastic modulus or flexural modulus of elasticity >1600 MPa and a yield strength <26 MPa.

Advantageously, the component is sufficiently rigid (low deformability) and elastic, as required by the function thereof; the user, in fact, acts upon such component in order to dispense the product.

In addition, the Applicant has observed the excellent mutual engagement between the hinge portion of the trigger, the seat of the chassis and the engagement portion of the extension, despite all of the components being made of polyethylene.

### Nozzle, Cover, Seal, and Ring Nut

The dispensing head 10 furthermore comprises a nozzle 22 applied by being snapped onto the front end 176 of the extension 16, at the outlet of the dispensing duct 172 which is crossed by the dispensing axis Y and preferably rotatable about said dispensing axis Y, in order to impose a predefined shape onto the jet of dispensed liquid or else in order to close the dispensing duct 172.

The nozzle 22 is made of polyethylene in a single piece, for example by injection molding. In particular, the nozzle material has an elastic modulus or flexural modulus of elasticity, ≤1000 MPa, a yield strength ≤26 MPa, an elongation at yield >9% and an ESCR that does not reveal any breakage.

Advantageously, the rigidity of the nozzle is not excessive, such that it may be easily rotated by the user, but, at the same time, such as to ensure coupling to the chassis, and also optimal resistance to chemical attack insofar as the nozzle is continuously and inevitably in contact with the product.

The dispensing head 10 furthermore comprises a cover 24 applied to the extension 16 and to the chassis 12, configured such as to at least partially cover the components of the head.

The cover 24 is made of polyethylene in a single piece, for example by injection molding. In particular, the material has an elastic modulus or flexural modulus of elasticity of between 1300 and 1500 MPa, a yield strength ≥30 MPa and an ultimate elongation ≤7%.

Advantageously, the cover thus made is not excessively rigid and fragile, but has adequate impact resistance.

The dispensing head 10 furthermore comprises a seal 26, applied to the lower end 124 of the chassis 12 in order to make a liquid product seal between the chassis and the neck of the bottle.

The seal 26 is made of polyethylene in a single piece, for example by injection molding.

Finally, the dispensing head 10 comprises an internally threaded ring nut 28 which is rotatably engaged at the lower end 124 of the chassis 12 for a threaded connection to the neck of the bottle.

The ring nut 28 is made of polyethylene in a single piece, for example by injection molding.

In particular, the material of the ring nut has an elastic modulus or flexural modulus of elasticity of between 1300 and 1500 MPa, a yield strength ≥30 MPa and an ESCR with the first break detected at ≥168 hours.

Advantageously, the ring nut is sufficiently rigid, but not in an excessive manner, such as to enable optimal coupling with the thread of the bottle ; it has, furthermore, optimal dimensional stability, in order to ensure the threaded coupling, and good chemical resistance in order to prevent breakages in the case of coming into contact with aggressive products contained within the bottle.

### Bottle

The bottle of the dispensing device, whereto the dispensing head 10 is applied, is made of polyethylene in a single piece, for example by EMB-extrusion blow molding.

### Operation

Under normal operation of the dispensing head 10, in an initial or rest configuration, the pumping member 12 is at a lower limit position wherein the cup 146 is undeformed and the pressure chamber 18 is at maximum volume, the trigger 20 is in an advanced limit position wherein the lever 202 is distal from the chassis axis X, the tube 146 of the pumping member is in a lower limit position, wherein there is a seal between the upper segment 148 and the guide wall 128 of the chassis 12, and the passage 170 is closed by the end segment 146a of the cup 146. It is recognized that the pressure chamber 18 contains a dose of liquid product to be dispensed.

During a dispensing step, the user manually operates the trigger 20, bringing the dispensing head 10 from the initial configuration towards a final dispensing configuration wherein the lever 202 of the trigger 20 is in proximity to the chassis axis X, the operating portion 204 of the trigger 20 has deformed the cup 146 in bringing the pressure chamber 18 to the minimum volume and the tube 146 is translated from the lower limit position to the upper limit position, wherein the upper segment 148 no longer seals against the guide wall 126.

During the dispensing step, the pressure of the liquid within the pressure chamber 18 acts upon the end segment 146a of the cup 146, flexing it such as to open the passage 170. The dose of liquid product thus emerges from the pressure chamber 18, is brought through the nozzle 22 into the dispensing duct 172 and is sprayed outwards.

At the same time, the pressure within the pressure chamber 18 operates upon the head 144 of the pumping member 12, closing the incision 152, such that the liquid product contained within the pressure chamber 18 may not return to the bottle through the tube 146 (and the suction tube).

During a suction step, which is initiated in releasing the trigger 20, the cup 146, which may be elastically deformed, tends to return to the undeformed condition of the initial configuration, thus acting upon the trigger 20 which returns to the initial position. The low pressure that is created within the pressure chamber 18 causes the end segment 146a of the cup 146 to adhere to the inner part 162c of the extension 16, sealingly closing the passage 170, thus preventing the return of the liquid product from the dispensing duct 172 to the pressure chamber 18.

At the same time, the low pressure within the pressure chamber 18 operates upon the head 144 of the pumping member 12, opening the incision 152, such that another dose of liquid product is drawn from the bottle and introduced into the pressure chamber 18. During such step, a predefined quantity of air enters from the outside into the chassis 12 and from there into the bottle by means of the gap that is formed between the guide wall 128 of the chassis and the lower segment 150 of the tube 142.

### SP Embodiment (Pre-Compressed)

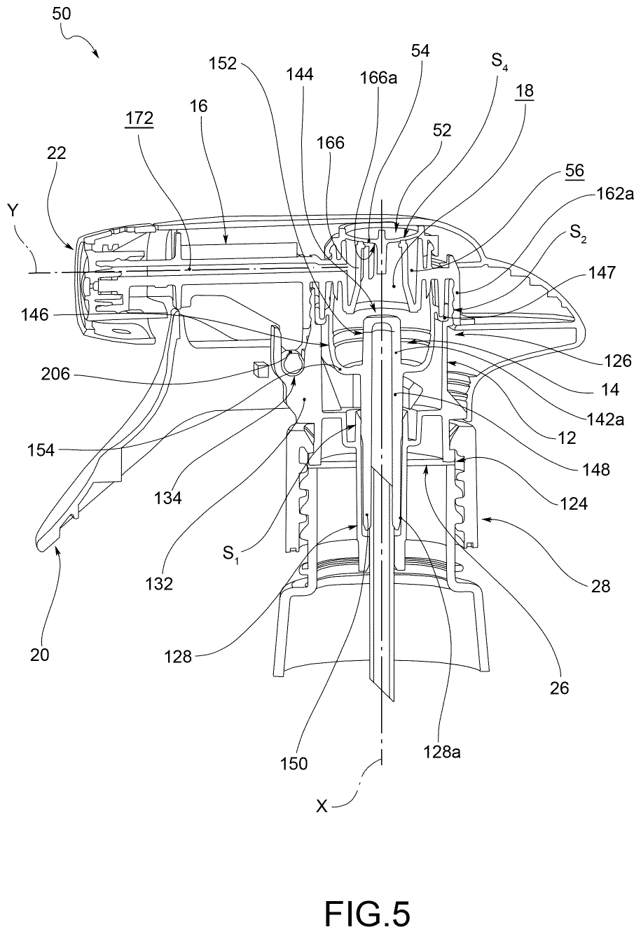

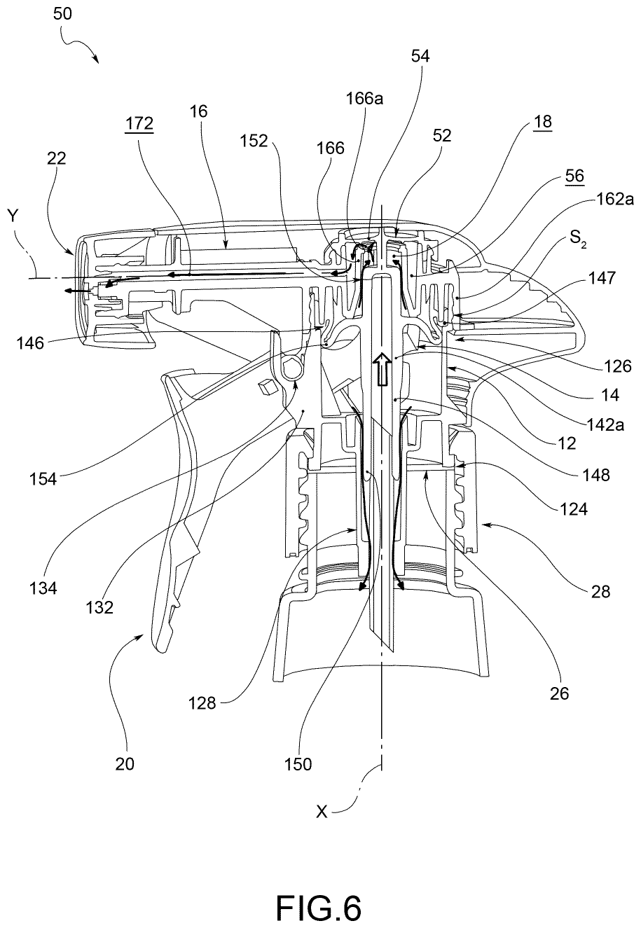

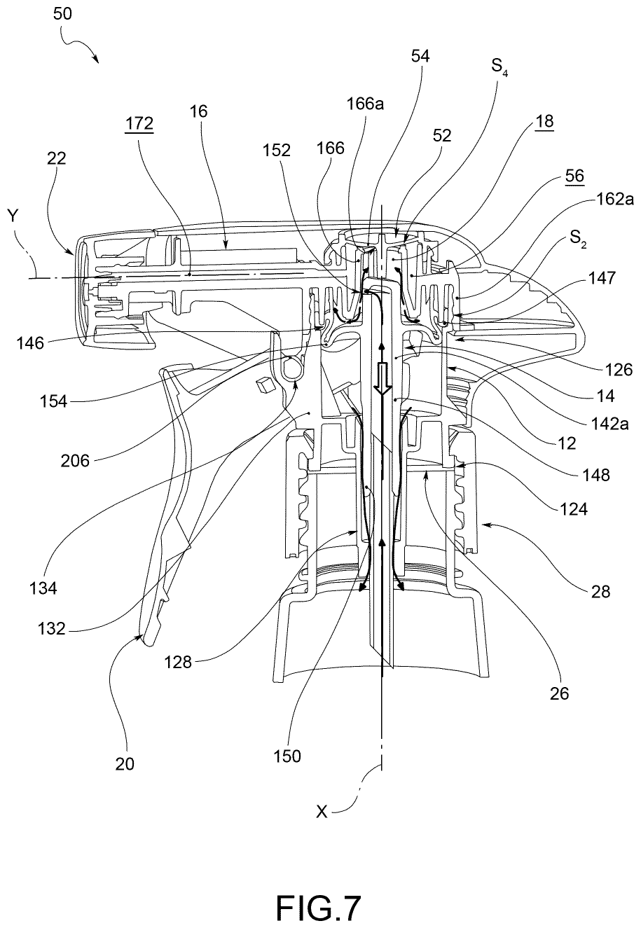

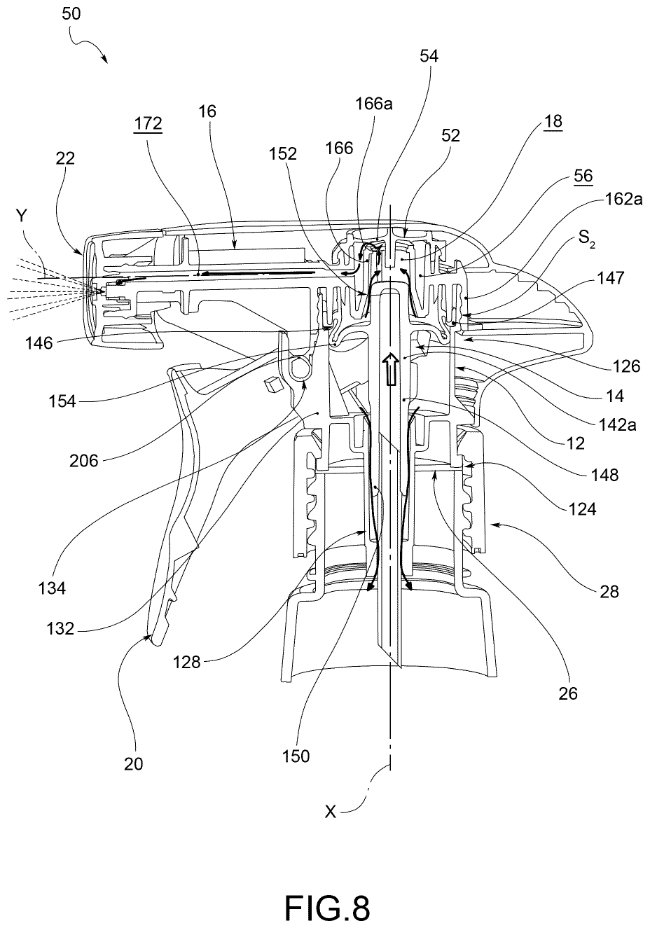

According to a further embodiment (FIGS. 5 to 8), within the dispensing head 50 the pressure chamber 18 is separate from the dispensing duct 172 of the extension 16, insofar as the extension 16 is devoid of the passage 170; in particular, the inner wall 162c of the extension 16 separates the pressure chamber 18 from the dispensing duct 172.

In addition, the bell 166 is itself opened at the top by a bell opening 166a and the dispensing head 50 comprises a pre-compression valve 52 applied to the top of the bell 166.

The pre-compression valve 52 is applied to the extension 16, and in particular to the connecting portion 162 thereof, and comprises a flexible membrane 54 that is suitable for closing the bell opening 166a thereby forming a fourth seal S4. Furthermore, the membrane 54, together with the bell 166, which is external thereto and to the inner wall 162c, delimits an annular space 56 that is in communication with the dispensing duct 172.

The pre-compression valve 52 is suitable for passing from a closing configuration, wherein the membrane 54 closes the bell opening 166a and prevents the passage of liquid product from the pressure chamber 18 to the space 56, to an opening configuration wherein, when the pressure within the pressure chamber 18 is greater than a predefined threshold value, the membrane 54 disengages from the bell opening 166a and allows the passage of the liquid product from the pressure chamber 18 to the space 56.

The pre-compression valve 52 is made of polyethylene in a single piece, for example by injection molding. In particular, the material of the pre-compression valve has an elastic modulus or a flexural modulus of elasticity >1600 MPa, a yield strength ≤26 MPa and an ESCR with the first break detected at ≥96 hours.

Advantageously, the pre-compression valve is sufficiently rigid to ensure the correct functionality, i.e. only opening when a threshold value of the pressure within the pressure chamber is exceeded, and is sufficiently resistant to chemical agents insofar as it enters into contact with the product. In addition the Applicant has observed the optimal functionality of the fourth seal, despite the pre-compression valve and the extension being made of polyethylene having differing features.

Innovatively, the trigger dispensing head according to the present invention and the dispensing device overcome the drawbacks of the prior art and satisfy the requirements of the sector, particularly with regard to disposal insofar as all of the components are made of the same material.

Advantageously, furthermore, all of the components have adequate mechanical strength according to the functions each has to perform and do not incur breakage or excessive deformation during the normal use of the device.

According to a further advantageous aspect, all of the components have excellent moldability and show no criticality during the production steps.

Additionally, advantageously, the head and the device exhibit highly efficient operation; in particular, the seals between the various components, both static and dynamic, are extremely effective thereby greatly preventing or limiting any liquid product leakage or unwanted spillage.

It is understood that those skilled in the art, in order to meet contingent needs, could make modifications to the head, the individual components that comprise the head and to the device described above, all of which are contained within the scope of protection as defined by the following claims.

What is claimed is

1-19. (canceled)

20. A trigger dispensing head applicable to a bottle for a liquid product dispensing device, comprising:
a chassis for connecting and supporting components of the trigger dispensing head, comprising at a bottom a cylindrical annular guide wall having a chassis axis and at a top a coupling portion, the chassis being molded in a single piece of polyethylene having an elastic modulus ≥1600 MPa and a yield strength ≤26 MPa;
a pumping member comprising a tube for suction of a liquid product, coaxial to the chassis axis, sealingly sliding in the cylindrical annular guide wall of the chassis, a head for the liquid product to pass in a pressure chamber during a suction step, and a cup at least partially delimiting the pressure chamber, partially deformable for dispensing the liquid product and comprising an engagement portion, the pumping member being molded in a single piece of polyethylene;
an extension comprising a connecting portion comprising an annular outer wall having an axial extension connected to the chassis by snapping onto the coupling portion, a dispensing portion comprising a dispensing duct extending along a dispensing axis perpendicular to the chassis axis and adapted to be put in communication with the pressure chamber, the extension being molded in a single piece of polyethylene having an elastic modulus between 1300 and 1500 MPa, a yield strength ≥30 MPa, and an environmental stress cracking resistance (ESCR) with a 1^{st} break detected ≥168 hours;
a trigger manually operable and operating on the engagement portion of the pumping member, the trigger being molded in a single piece of polyethylene;
a nozzle applied to the extension, at an outlet of the dispensing duct, rotatable about the dispensing axis, molded in a single piece of polyethylene;
a cover applied to the extension and to the chassis, configured to cover at least partially the components of the trigger dispensing head, molded in a single piece of polyethylene; and
a ring nut, internally threaded, rotatably engaged with the chassis for connection with the bottle, molded in a single piece of polyethylene;
wherein the tube of the pumping member and the cylindrical annular guide wall of the chassis form a first seal which is both static and sliding, between components made of polyethylene.

21. The trigger dispensing head of claim 20, wherein the pumping member further comprises a flange radially extending outward from the cup, compressed between the chassis and the extension, and wherein the flange of the pumping member, the chassis, and the extension make a second static seal between the components made of polyethylene.

22. The trigger dispensing head of claim 20, wherein the chassis comprises at a front thereof an engagement portion in which a seat open at a top is formed, the extension comprises an engagement portion extending toward the seat of the chassis, and the trigger comprises a hinge portion accommodated in the seat to form a pivot pin and kept in the seat by the engagement portion.

23. The trigger dispensing head of claim 20, wherein a material of the pumping member has different mechanical features from a material of the chassis.

24. The trigger dispensing head of claim 20, wherein a material of the pumping member has a melt flow rate ≥6 g/10 minutes, an ultimate tensile strength ≤20 MPa, and an ultimate tensile elongation ≥900%.

25. The trigger dispensing head of claim 20, wherein a material of the trigger has an elastic modulus or a flexural modulus of elasticity ≥1600 MPa and a yield strength ≤26 MPa.

26. The trigger dispensing head of claim 20, wherein a material of the nozzle has an elastic modulus or a flexural modulus of elasticity ≤1000 MPa, a yield strength ≤26 MPa, an elongation at yield ≥9%, and an ESCR showing no breakage.

27. The trigger dispensing head of claim 20, wherein a material of the ring nut has an elastic modulus or a flexural modulus of elasticity from 1300 to 1500 MPa, a yield strength ≥30 MPa, and an ultimate elongation ≤7%.

28. The trigger dispensing head of claim 20, wherein a material of the ring nut has an elastic modulus or a flexural modulus of elasticity between 1300 and 1500 MPa, a yield strength ≥30 MPa, and an ESCR with the 1^{st} break detected ≥168 hours.

29. The trigger dispensing head of claim 20, wherein the connecting portion of the extension comprises an annular inner wall having a predefined axial extension, on which, during the suction step, an end segment of the cup rests, and wherein the connecting portion and the end segment make a third seal between the components made of polyethylene, between the pressure chamber and the dispensing duct.

30. The trigger dispensing head of claim 20, further comprising a pre-compression valve operating between the pressure chamber and the dispensing duct, wherein the pre-compression valve is applied to the extension, comprises a flexible membrane and is molded in a single piece of polyethylene, so that the flexible membrane and the extension form a fourth seal between the components made of polyethylene.

31. The trigger dispensing head of claim 30, wherein a material of the extension has different mechanical features from a material of the pre-compression valve.

32. The trigger dispensing head of claim 30, wherein a material of the pre-compression valve has an elastic modulus or a flexural modulus of elasticity ≥1600 MPa, a yield strength ≤26 MPa, and an ESCR with the 1^{st} break detected ≥96 hours.

33. A liquid product dispensing device, comprising:
a bottle, and
the trigger dispensing head of claim 20, applied to the bottle.

34. The liquid product dispensing device of claim 33, wherein the bottle is made of polyethylene.
